(19) United States
(12) Patent Application Publication
(10) Pub. No.: US 2023/0253569 A1
(43) Pub. Date: Aug. 10, 2023

(54) BIPOLAR BATTERY PLATE CONFIGURATION AND FABRICATION TECHNIQUES

(71) Applicant: Gridtential Energy, Inc., Santa Clara, CA (US)

(72) Inventors: Peter Gustave BORDEN, San Mateo, CA (US); Daniel Jason MOOMAW, Santa Clara, CA (US); Esteban M. HINOJOSA, San Jose, CA (US)

(21) Appl. No.: 18/106,389

(22) Filed: Feb. 6, 2023

Related U.S. Application Data
(60) Provisional application No. 63/306,602, filed on Feb. 4, 2022.

(51) Int. Cl. H01M 4/73; H01M 4/14; H01M 4/68

(52) U.S. Cl. CPC H01M 4/73; H01M 4/14; H01M 4/68

(57) ABSTRACT

A current collector plate assembly including a polygon-shaped electrically conductive substrate having a first surface and a second, opposing, surface, and at least three edges. A frame is coupled to regions of the first and second surfaces near the at least three edges of the substrate. A first cladding of a positive active materials layer covers an area of the first surface of the substrate. A second cladding of a negative active materials layer covers an area of the second surface of the substrate.

### CROSS REFERENCE TO RELATED APPLICATIONS

This non-provisional U.S. utility patent application is related to, and claims priority to, provisional patent application No. 63/306,602 filed Feb. 4, 2022, entitled “Bipolar Battery Plate Configuration and Fabrication Techniques”, the contents of which are incorporated herein by reference in their entirety.

### TECHNICAL FIELD

This document pertains generally, but not by way of limitation, to battery technology, and more particularly, to battery plate fabrication and processing techniques, such as for use in a bipolar battery configuration.

### BACKGROUND

The lead acid battery, invented by Gaston Planté in 1859, can be considered the oldest and most common type of secondary (e.g.; rechargeable) battery. Applications for lead acid batteries include automotive starting, ignition, and lighting), traction (e.g., vehicular drive), and stationary (e.g., back-up power supply) applications. Despite simplicity and low cost, generally available monopolar lead acid technology may present several shortcomings related to architecture and materials used in the battery. For example, generally available monopolar lead acid batteries have relatively lower energy densities as compared to other chemistries such as lithium ion. Also, cycling performance of monopolar lead acid batteries is often poor under high-current-rate or deep discharge conditions. In addition, monopolar lead acid batteries may suffer from poor partial-state-of-charge performance, and often have high self-discharge rates relative to other technologies.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates a front elevation view of a bipolar battery plate assembly in accordance with embodiments of the invention.

FIG. 2 illustrates a section view of a bipolar battery plate assembly in accordance with embodiments of the invention.

FIG. 3 illustrates a front elevation view of a bipolar battery plate assembly in accordance with embodiments of the invention.

FIG. 4A is a top view of aspects of a bipolar battery plate assembly in accordance with embodiments of the invention.

FIG. 4B is a side view of aspects of a bipolar battery plate assembly in accordance with embodiments of the invention.

FIG. 5A is a top view of aspects of a bipolar battery plate assembly in accordance with embodiments of the invention.

FIG. 5B is a top view of aspects of a bipolar battery plate assembly in accordance with embodiments of the invention.

FIG. 6A is a top view of aspects of a bipolar battery plate assembly in accordance with embodiments of the invention.

FIG. 6B is a top view of aspects of a bipolar battery plate assembly in accordance with embodiments of the invention.

### DETAILED DESCRIPTION

In a bipolar battery architecture, electrochemical cells are generally connected electrically in series. In this configuration, a current collector connects neighboring cells electrically (e.g., through a conductive substrate) and adjacent cells are electrochemically isolated from each other, such as hermetically. Plates in the bipolar battery architecture generally comprise a current collector with positive and negative active materials deposited on opposite sides of the plate, respectively.

Generally, a bipolar battery plate assembly, or simply, a “biplate” assembly includes several features. For example, the biplate assembly, when forming a portion of an overall battery assembly must provide or accommodate sealing to prevent leakage of electrolyte out of the battery or between cells. Generally, electrically active portions of the biplate must be substantially or entirely covered with active material to eliminate parasitic current paths. The biplate assembly is generally specified to be mechanically thin to reduce or minimize weight, but rigid enough to maintain durability and enable being mounted or supported within a battery assembly. Materials used for the biplate assembly are generally specified to be impervious to attack by a corrosive electrolyte. Also, the biplate configuration is generally arranged to direct current flow in a direction perpendicular to a face or active surface to reduce or minimize current crowding (e.g., to provide uniform current flow through the cross section of the plate assembly in a direction perpendicular to the faces or active surfaces of the plate assembly).

In one approach, a substrate for a biplate assembly can include a doped conductive) silicon core, clad with layers of other materials, such as plated with lead with an overlaid active material layer. The active material can be screen printed or otherwise applied, as a paste, for example, or deposited or electroplated. The present inventors have recognized, among other things, that another approach can include use of a lead sheet. Use of a lead sheet, such as without requiring a separate conductive silicon core, can present various challenges. For example, a biplate using a lead sheet should support or accommodate a seal structure, suppress parasitic current paths, and generally should not contribute excess weight to a battery assembly. In one approach, via structures can be used between front and back surfaces or plates forming a biplate assembly, but such a via-based approach can create undesired current crowding. By contrast, the present inventors have developed biplate configurations and techniques as described below herein, such as to provide one or more of sealing, suppression of parasitic current paths, and reduction of weight as compared to other approaches.

Characteristics of bipolar batteries are influenced by the materials and processing used for the bipolar current collector assemblies or “biplate” assemblies. Generally, a bipolar current collector assembly cats be specified to provide an electrically conductive substrate that is mechanically light, resistant to mechanical damage, and resistant to acid corrosion (e.g., sulfuric acid). The current collector substrate is also generally specified to inhibit or suppress electrolyte diffusion to maintain isolation between adjacent cells. The current collector substrate is generally specified to be electrochemically stable within the operating range of the battery chemistry (e.g., lead acid chemistry).

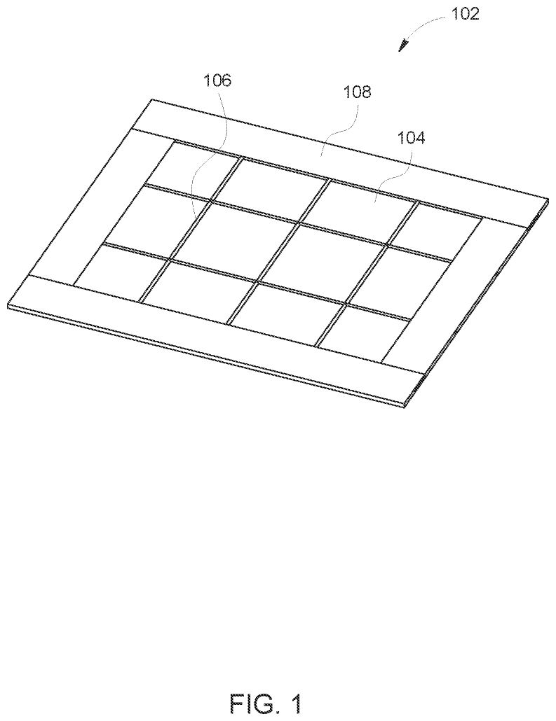

FIGS. 1-6B illustrate generally a bipolar battery plate assembly 102, 302. A thin lead sheet 104 can have thickness from about 50 to about 200 microns e.g., (2 to 8 mils) (although thicker sheets, for example, up to 500 microns, are possible). In another example, the sheet 104 can be silicon. In yet another example, the sheet 104 can be metal, such as lead, or steel, having a thickness, for example, from 10 to 50 microns and coated (e.g., laminated) in silicon, wherein the silicon is deposited on the surfaces of the metal to ensure that the sheet 104 does not corrode. Finally, in one example, the sheet can be a silicon substrate coated in a thin metal sheet having a thickness from 10-50 microns. The lead, steel, silicon-cladded lead or steal, silicon sheet, or metal-cladded silicon sheet 104 can be surrounded around its perimeter using a polymer (e.g., plastic) structure 108. The polymer structure 108 can entirely cover an edge of the sheet 104, which is rectangular as shown in FIGS. 1-6B but may be another shape.

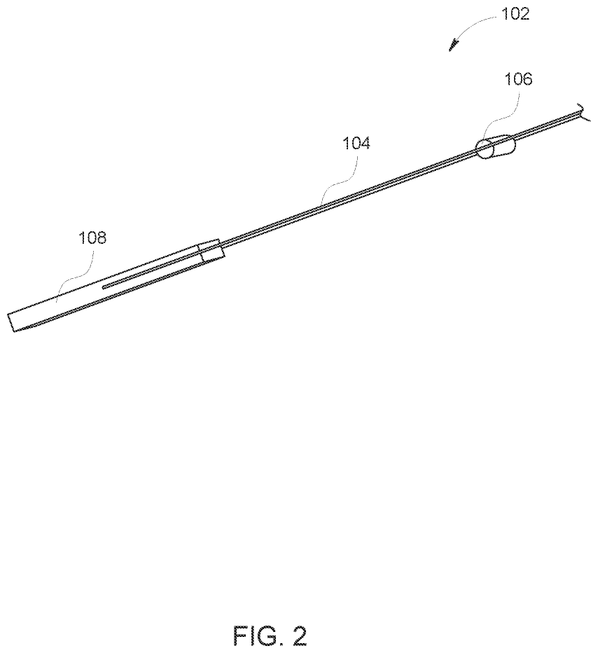

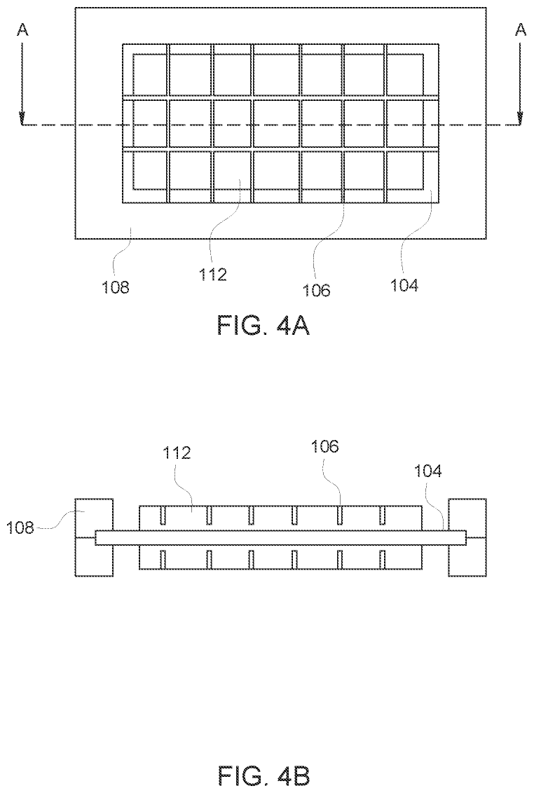

In the illustrative examples of FIGS. 1-6B, the assembly 102, 302 can include one or more support ribs (such as a rib 106), to provide mechanical support for the sheet 104 structure. The one or more support ribs can be constrained or embedded within the polymer structure 108 or unitized with the polymer structure 108. A cross section of the one or more support ribs can be semispherical, rectangular or triangular, with a triangular shape having reduced weight and material content, as an illustrative example. The one or more support ribs are spaced in a manner that can provide structural support to the sheet 104, and such ribs can provide structure to support an active material paste that is located upon one or both of the opposite surfaces of the plate. For example, the ribs can be included on both surfaces of the sheet 104 as depicted in FIGS. 2 and 4B.

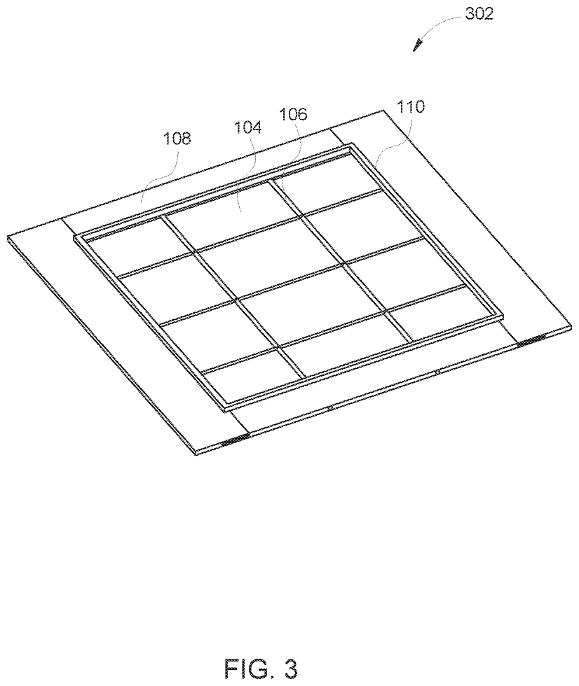

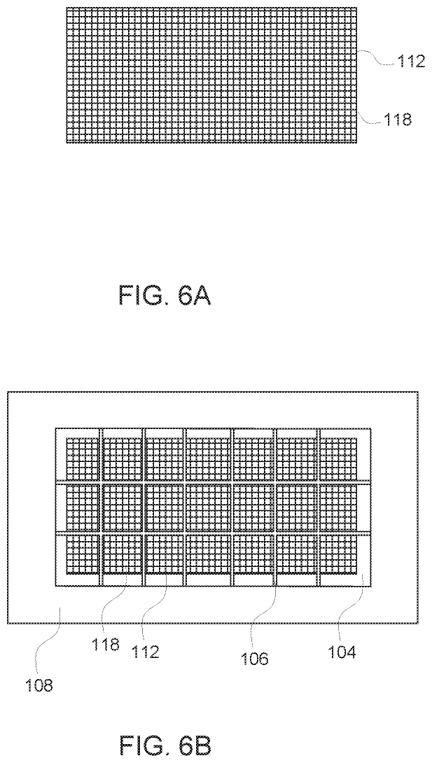

In an example, such as following sealing of the edges of the sheet 104, the sheet 104 can be coated on one or both surfaces with active material 112 as illustrated in FIGS. 4A, 4B, 6A and 6B. Such a coating process can use screen printed pastes, for example. For a lead-acid battery, the pastes are generally wet pastes comprising lead oxide, lead sulphate, or elemental lead, for example. The edges of the sheet 104 may be masked to suppress coating of the polymer structure 108 (e.g., to suppress coating of the support frame). As an illustrative example, a negligible amount of paste (<1% of the area) can be deposited on the polymer structure 108 versus the sheet 104. In another example, a deposited paste overlaps an inner edge of polymer structure 108. In yet another example, with reference to FIG. 3, the paste area is defined by a lip structure 110, shown illustratively in the example of a plate assembly 302. Referring to FIGS. 1-4B, the plate assembly 102, 302 can be placed in a carrier that defines a window so that coating occurs over a specified exposed plate active area, such as during a screen-printing process. In an illustrative example, all hut a small portion around the edges of the exposed sheet 104 surface is covered with active material 112 after processing.

The examples of FIGS. 1-3 leave a significant proportion of the sheet 104 active area exposed so that current flow is substantially perpendicular to the plane of the sheet 104, and there is negligible current crowding. In an example, only one side of the sheet 104 is pasted and a sheet of paste is separately formed and affixed to the opposite side. In yet another example, for example, with reference to FIG. 4B, polymer structure 108 can define or include ribs 106 that substantially embed into, and clamp, a sheet of active material paste to a surface of the sheet 104.

FIG. 2 illustrates generally a section view of a portion of the plate 102 of FIGS. 1 and 3. For example, a polymer structure 108 can include top and bottom (or front and back or left and right, depending on the perspective) portions that clamp to a lead sheet 104 or another conductive sheet from top and bottom. For example, the structure 108 can include portions that are thermally sealed together to provide a solid frame structure. In another example, a seal is formed by the structure 108 during or after mating using an adhesive or a cement that attacks or otherwise fuses a polymer comprising the structure 108. In yet another example, a seal is formed using vibration such as ultrasonic welding of portions forming the structure 108. In an example, the structure 108 can include features that can focus ultrasonic energy to facilitate bonding of portions forming the structure 108. In an example, an energy director can be formed into the structure 108 that, under ultrasonic force, can form a bond with sheet 104. In yet another example, laser ablation of the surfaces of structure 108 and sheet 104 can create a bond, such as when exposed to mechanical compression forces. Finally, in one example, a gasket may be used to seal between the structure 108 and the sheet 104 to allow the top and bottom portions of the structure 108 to be fused or welded together in a hermetic fashion and avoid the need to bond dissimilar materials.

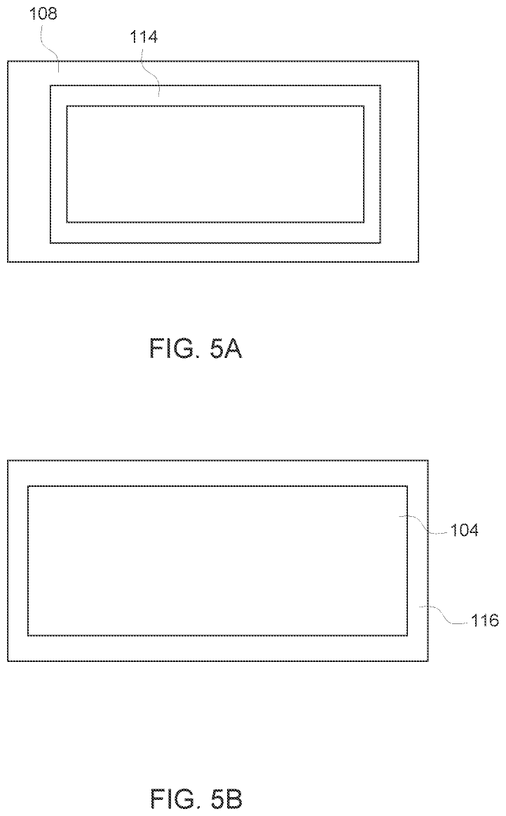

In an illustrative example, with reference to FIGS. 5A and 5B, surfaces of the structure 108 in contact with the sheet 104 can be coated with metal 114 (e.g., a thin electroless metal flash on the inner surface of structure 108) to form a seal with the sheet 104 around the sheet 104 circumference. For example, an inner surface of the structure 108 can have an electroless coating 114 of a metal such as tin or indium. The tin will form a eutectic with a lead sheet 104 to provide a seal, such as during thermal bonding of the structure 108 with the sheet 104. In an example, a surface of the sheet 104 near the edge region of the sheet 104 or the structure 108 (or both) can include an adhesion coating. In an example, a thin strike of plated lead, or lead-tin alloy, 116 can be formed over the electroless metal coating 114 mentioned above, and a seal between the structure 108 and the sheet 104 can be lead-to-lead. In one embodiment, the metal 114 and plated lead or lead-tin alloy 116 could be soldered together. In an example, one or more of the metal coating processes mentioned above can include a vapor deposition process.

Referring to FIG. 3, the structure 108 can include a lip 110. For example, the lip 110 can include or can define a knife edge. The lip 110 can constrain the applied active material 112 to a region where the sheet 104 is exposed, such as to reduce flaking at the paste edges. The knife edge can be used to cut the paste. For example, the paste may have poor adhesion to the structure 108. Paste deposited on the structure 108 can be removed, such as with the help of a knife edge on the lip 110, because the lip 110 can isolate or disconnect paste deposited on the structure 108 from paste within the region where the sheet 104 is exposed. In an example, with reference to FIGS. 6A and 6B, a mesh 118 can be inserted within an area defined by the inner edge of the structure, for example, defined by the lip 110, such as to provide structure to support or retain applied paste. In another example, the support ribs 106 are closely spaced to define the mesh 118 to support or retain the applied paste (not shown).

Thus, disclosed herein is a current collector plate assembly, comprising: a polygon-shaped electrically conductive substrate (hereinafter “substrate”) having a first surface and a second, opposing, surface, and at least three edges; a frame coupled to regions of the first and second surfaces near the at least three edges of the substrate; a first cladding of a positive active materials layer covering an area of the first surface of the substrate; and, a second cladding of a negative active materials layer covering an area of the second surface.

In one embodiment of the current collector plate assembly, the areas of the first and second surfaces covered by the respective first and second claddings are circumscribed inside, at, or outside, an inner edge of the frame.

In one embodiment of the current collector plate assembly, the frame comprises a raised lip at an inner edge of the frame.

In one embodiment of the current collector plate assembly, the raised lip at the inner edge of the frame defines a knife edge by which the areas of the first and second surfaces covered by the respective first and second claddings are circumscribed at the inner edge of the frame at the time of cladding.

In one embodiment of the current collector plate assembly, a composition of the substrate is selected from a group of compositions consisting of: lead, silicon, and doped silicon.

In one embodiment of the current collector plate assembly, the substrate has an approximate thickness of 50 to 500 micrometers. In the example where the substrate is silicon, the substrate may have an approximate thickness of more than 500 micrometers, in one example, such a substrate may have a thickness of up to 1500 micrometers.

In one embodiment of the current collector plate assembly, a plurality of ribs is coupled to the frame and span across one of: the area of the first surface of the substrate defined by the frame, the area of the second surface of the substrate defined by the frame, or both, to provide structural support for the substrate.

In one embodiment of the current collector plate assembly, the plurality of ribs further span across one of: the first cladding, the second cladding, or both, to clamp the respective first cladding, second cladding, or both claddings, to the respective first and second surfaces of the substrate.

In one embodiment of the current collector plate assembly, a composition of the frame is selected from a group consisting of: a polymer, and a plastic.

In one embodiment of the current collector plate assembly, the first and second claddings comprise a paste selected from a group consisting of: lead oxide, lead sulphate, and lead.

In one embodiment of the current collector plate assembly, a mesh is coupled to the frame and spanning across one of: the area of the first surface of the substrate defined by the frame, the area of the second surface of the substrate defined by the frame, or both, to provide structural support for the paste.

In one embodiment of the current collector plate assembly, the frame coupled to regions of the first and second surfaces near the at least three edges of the substrate comprises a first portion of the frame coupled to regions of the first surface near the at least three edges of the substrate and a second portion of the frame coupled to regions of the second surface near the at least three edges.

In one embodiment of the current collector plate assembly, the first and second portions of the frame are coupled to each other by one of: thermal bonding, an adhesive, ultrasonic welding, laser ablation in combination with mechanical compression forces, and a cement.

In one embodiment of the current collector plate assembly, the frame coupled to regions of the first and second surfaces near the at least three edges of the substrate comprises an inner surface coupled to regions of the first and second surfaces near the at least three edges of the substrate, and wherein the inner surface is coated with an adhesion material to form a seal with the substrate around the at least three edges of the substrate.

In one embodiment of the current collector plate assembly, the adhesion material is applied to the frame according to a process selected from a group consisting of: electroless deposition and vapor deposition.

In one embodiment of the current collector plate assembly, the adhesion material on the inner surface of the frame comprises an electroless coating of a metal selected from a group consisting of: lead, tin, and indium.

In one embodiment of the current collector plate assembly, the regions of the first and second surfaces near the at least three edges of the substrate is coated with an adhesion coating to facilitate the seal with the inner surface of the frame.

The above detailed description includes references to the accompanying drawings, which form a part of the detailed description. The drawings show, by way of illustration, specific embodiments in which the invention can be practiced. These embodiments are also referred to generally as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following aspects, the terms “including” and “comprising” are open-ended, that is, a system, device, article, composition, formulation, or process that includes elements in addition to those listed after such a term in a claim are still deemed to fall within the scope of that claim. Moreover, in the following aspects, the terms “first,” “second,” and “third,” etc., are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following aspects are hereby incorporated into the Detailed Description as examples or embodiments, with each aspect standing on its own as a separate embodiment, and it is contemplated that such embodiments can be combined with each other in various combinations or permutations.

1. A current collector plate assembly, comprising:
a polygon-shaped electrically conductive substrate (hereinafter “substrate”) having a first surface and a second, opposing, surface, and at least, three edges; and
a frame coupled to regions of the first and second surfaces near the at least three edges of the substrate.

2. The current collector plate assembly of claim 1, further comprising a first cladding of a positive or negative active materials layer covering an area of the first surface of the substrate.

3. The current collector plate assembly of claim 2, further comprising a second cladding of an active materials layer covering an area of the second surface of the substrate, wherein the active materials layer is a complement of the positive or negative active materials layer covering the first surface of the substrate.

4. The current collector plate assembly of claim 1, wherein the areas of the first and second surfaces covered by the respective first and second claddings are circumscribed inside, at, or outside, an inner edge of the frame.

5. The current collector plate assembly of claim 1, wherein the frame comprises a raised lip at an inner edge of the frame.

6. The current collector plate assembly of claim 5, wherein the raised lip at the inner edge of the frame defines a knife edge by which the areas of the first and second surfaces covered by the respective first and second claddings are circumscribed at the inner edge of the frame at the time of cladding.

7. The current collector plate assembly of claim 1, wherein a composition of the substrate is selected from a group of compositions consisting of: lead, steel, silicon, silicon-cladded lead, silicon-cladded steel, and doped silicon.

8. The current collector plate assembly of claim 1, wherein the substrate has an approximate thickness of 50 to 500 micrometers.

9. The current collector plate assembly of claim 1, wherein the substrate is silicon and has an approximate thickness of 50 to 1500 micrometers.

10. The current collector plate assembly of claim 1, further comprising a plurality of ribs coupled to the frame and spanning across one of: the area of the first surface of the substrate defined by the frame, the area of the second surface of the substrate defined by the frame, or both, to provide structural support for the substrate.

11. The current collector plate assembly of claim 10, wherein the plurality of ribs further span across one of: the first cladding, the second cladding, or both, to clamp the respective first cladding, second cladding, or both claddings, to the respective first and second surfaces of the substrate.

12. The current collector plate assembly of claim 1, wherein a composition of the frame is selected from a group consisting of: a polymer, and a plastic.

13. The current collector plate assembly of claim 1, wherein the first and second claddings comprise a paste selected from a group consisting of: lead oxide, lead sulphate, and lead.

14. The current collector plate assembly of claim 1, further comprising a mesh coupled to the frame and spanning across one of: the area of the first surface of the substrate defined by the frame, the area of the second surface of the substrate defined by the frame, or both, to provide structural support for the paste.

15. The current collector plate assembly of claim 1, wherein the frame coupled to regions of the first and second surfaces near the at least three edges of the substrate comprises:
a first portion of the frame coupled to regions of the first surface near the at least three edges of the substrate; and
a second portion of the frame coupled to regions of the second surface near the at least three edges.

16. The current collector plate assembly of claim 15, wherein the first and second portions of the frame are coupled to each other by one of: a thermal bonding process, an adhesive, an ultrasonic welding process, a laser ablation process in combination with application of mechanical compression forces, and a cement.

17. The current collector plate assembly of claim 1, wherein the frame coupled to regions of the first and second surfaces near the at least three edges of the substrate comprises an inner surface coupled to regions of the first and second surfaces near the at least three edges of the substrate, and wherein the inner surface is coated with an adhesion material to form a seal with the substrate around the at least three edges of the substrate.

18. The current collector plate assembly of claim 17, wherein the adhesion material is applied to the frame according to a process selected from a group consisting of: electroless deposition, vapor deposition, and electroplating.

19. The current collector plate assembly of claim 17, wherein the adhesion material on the inner surface of the frame comprises an electroless coating of a metal selected from a group consisting of: lead, tin, and indium.

20. The current collector plate assembly of claim 17, wherein the regions of the first and second surfaces near the at least three edges of the substrate are coated with an adhesion coating to facilitate the seal with the inner surface of the frame.

21. The bipolar battery comprising a current collector plate assembly as recited claim 1.

22. The current collector assembly of claim 1, further comprising a gasket to create a hermetic seal between the frame and the substrate.
